(19) United States
(12) Patent Application Publication
(10) Pub. No.: US 2025/0131411 A1
(43) Pub. Date: Apr. 24, 2025

(54) SYSTEMS AND METHODS OF DISABLING A CONTACTLESS CARD FOR FRAUD PREVENTION

(71) Applicant: Capital One Services, LLC, McLean, VA (US)

(72) Inventors: Jeffrey RULE, Chevy Chase, MD (US); Kevin OSBORN, Newton Highlands, MA (US)

(73) Assignee: Capital One Services, LLC, McLean, VA (US)

(21) Appl. No.: 18/918,482

(22) Filed: Oct. 17, 2024

Related U.S. Application Data
(60) Provisional application No. 63/544,985, filed on Oct. 20, 2023.

(51) Int. Cl. G06Q 20/34; G06Q 20/40

(52) U.S. Cl. CPC G06Q 20/341; G06Q 20/352; G06Q 20/4016

(57) ABSTRACT

A method of disabling a contactless card for fraud prevention is provided. The method includes determining that the contactless card is fraudulent, which includes at least one of determining that a trust level score of the contactless card is less than a trust level threshold, determining that the contactless card is lost, or determining that the contactless card is stolen. The method further includes disabling the contactless card, which comprises at least one selected from the group of overwriting an applet on the contactless card, changing public keys on the contactless card, deleting public and private keys on the contactless card, changing a private key on the contactless card, and modifying a payment applet on the contactless card to accept a temporary disabling signal.

### CROSS-REFERENCE TO RELATED APPLICATION

This application claims priority to U.S. Provisional Patent Application No. 63/544,985, filed on Oct. 20, 2023, the contents of which are incorporated herein by reference in their entirety.

### FIELD OF THE INVENTION

The present disclosure relates generally to contactless card security, and more particularly, to systems and methods of disabling a contactless card for fraud prevention.

### BACKGROUND

Contactless card data security and transaction integrity are of critical importance to businesses and consumers. Fraudulent transactions can be very costly and disruptive for businesses and consumers, and attempts by fraudulent actors to perform fraudulent transactions or other fraudulent activity are increasing.

Currently, financial institutions or other card issuing and/or servicing institutions have no way to disable contactless cards. For example, when a contactless card is reported as lost or stolen, future transactions associated with that contactless card can be denied. However, that contactless card is unmodified, so any transactions can still be processed before future transactions are denied, which allows fraudulent actors to attempt fraudulent transactions or other fraudulent activity before they are blocked.

These and other deficiencies exist. Accordingly, there is a need to provide systems and methods that overcome these deficiencies to improve data security and transaction integrity, prevent financial loss, and reduce fraud.

### SUMMARY

Embodiments of the present disclosure provide a method of disabling a contactless card for fraud prevention. The method includes determining that the contactless card is fraudulent, comprising at least one selected from the group of determining that a trust level score of the contactless card is less than a trust level threshold, determining that the contactless card is lost, and determining that the contactless card is stolen; and disabling the contactless card, comprising at least one selected from the group of overwriting an applet on the contactless card, changing public keys on the contactless card, deleting public and private keys on the contactless card, changing a private key on the contactless card, and modifying a payment applet on the contactless card to accept a temporary disabling signal.

Embodiments of the present disclosure provide a system of disabling a contactless card for fraud prevention. The system includes a server. The server comprises a processor and a memory coupled to the processor. The server is configured to: determine that the contactless card is fraudulent, comprising at least one selected from the group of determining that a trust level score of the contactless card is less than a trust level threshold, determining that the contactless card is lost, and determining that the contactless card is stolen; and disable the contactless card, comprising at least one selected from the group of at least one of overwriting an applet on the contactless card, changing public keys on the contactless card, deleting public and private keys on the contactless card, changing a private key on the contactless card, and modifying a payment applet on the contactless card to accept a temporary disabling signal.

Embodiments of the present disclosure provide a non-transitory, computer-readable medium comprising instructions for disabling a contactless card for fraud prevention that, when executed on a computer arrangement, perform actions comprising: determining that the contactless card is fraudulent, comprising at least one selected from the group of at least one of determining that a trust level score of the contactless card is less than a trust level threshold, determining that the contactless card is lost, and determining that the contactless card is stolen; and disabling the contactless card, comprising at least one selected from the group of at least one of overwriting an applet on the contactless card, changing public keys on the contactless card, deleting public and private keys on the contactless card, changing a private key on the contactless card, and modifying a payment applet on the contactless card to accept a temporary disabling signal.

Further features of the disclosed systems and methods, and the advantages offered thereby, are explained in greater detail hereinafter with reference to specific example embodiments illustrated in the accompanying drawings.

### BRIEF DESCRIPTION OF THE DRAWINGS

FIG. 1 is a diagram of a system for disabling a contactless card according to an example embodiment.

FIG. 2 is a diagram of sequential interactions between components of the system in FIG. 1 according to an example embodiment.

FIG. 3A is a contactless card used for disabling the contactless card according to an example embodiment.

FIG. 3B is a diagram of the contact pad of the contactless card in FIG. 3A according to an example embodiment.

FIG. 4 is a flow chart of a method for disabling a contactless card according to an example embodiment.

FIG. 5 is a flow chart of a method of determining a contactless card as fraudulent according to an example embodiment.

FIG. 6 is a flow chart of a method of disabling a contactless card according to an example embodiment.

FIG. 7 is a flow chart of a method of disabling a contactless card according to an example embodiment.

### DETAILED DESCRIPTION OF EXAMPLE EMBODIMENTS

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

The described features and teachings of the embodiments may be combined in any suitable manner. A person of ordinary skill in the art will recognize that the embodiments may be practiced without one or more of the specific features and teachings of an embodiment. In other instances, additional features and teachings may be recognized in certain embodiments that may not be present in all embodiments. A person of ordinary skill in the art will understand that the described features and teachings of any embodiment can be interchangeably combined with the features and teachings of any other embodiment.

Financial institutions, such as banks, currently have no way to physically disable contactless cards when the contactless cards are determined to be fraudulent, lost, or stolen. Although further transactions on such contactless cards can be denied, the contactless cards themselves are unmodified. Example embodiments of the present disclosure provide systems and methods can allow the Europay, Mastercard, and Visa (EMV) applet on the contactless card itself to be disabled or deactivated and/or then reactivated over near field communication (NFC) from a mobile phone. Specifically, this can be done by a software development kit (SDK) (e.g., a bank's SDK embedded in a merchant website at the time of purchase). The SDK can be configured to connect back via application programming interfaces (APIs) to a financial institution that deploys the SDK.

In some embodiments, the SDK and the contactless card can exchange a digital certificate containing public keys, which can enable a secure communication channel between the SDK and the contactless card.

The SDK can be configured to build a fraud profile of a customer as the customer browses the merchant's website and to use identifiers (such as cookies and internet protocol (IP) addresses) to evaluate the fraud potential of the customer.

If the customer is determined to be a fraudulent actor, the contactless card can be disabled, for example, when NFC communications are established with the contactless card during checkout flow, even before the transaction. If a fraud is determined to be likely before checkout, the contactless card can be disabled during the transaction itself when the customer taps the contactless card to a mobile phone.

In some embodiments, a contactless card can be disabled for a number of reasons, including, but not limited to: data during a transaction indicates a fraud is likely; the contactless card is reported as lost or stolen; or a fraud on the contactless card is reported to a bank.

A contactless card can be disabled in a number of ways when the contactless card is in data communication with the mobile device and/or the point of sale terminal, some of which can be reversible and others of which can be permanent. The disabling methods can include, but are not limited to: an overwrite the EMV applet of the contactless card, which can permanently disable the contactless card; a change the public keys of the contactless card so an initial authorization cannot occur, which can permanently disable the contactless card; a deletion of the public and private keys of the contactless card; a change the private key of the contactless card, which can be changed back to reactivate the contactless card; and a modification the EMV payment applet to accept a temporary disabling signal, which can be accomplished by sending a signed command to the contactless card and the contactless card can verify the signature of the signed command with an embedded public key.

Example embodiments of the present disclosure provide systems and methods of disabling contactless cards for fraud prevention, such that fraudulent transactions and other fraudulent activities on the contactless cards can be prevented. The systems and methods disclosed herein can aggregate fraud data or information on the contactless cards to be able to build up a better fraud profile on the contactless cards. The fraud data can either be collected from a software development kit (SDK) that is embedded into the checkout flow of merchants or collected from information that the merchants might be able to provide. A trust level score of the contactless card can be generated based on the fraud profile to determine whether the contactless card is fraudulent. Example embodiments of the present disclosure can allow a contactless card to be disabled before a transaction takes place based on fraud data pre-collected by the network and SDK. The SDK can be embedded into websites of the merchants. The fraud data can include customer's behavioral data, customer's geolocation, customer's browsing history, customer's mouse movements, customer's base orientation, etc.

In some embodiments, the present disclosure can be applied to tap a mobile phone to a point of sale or transaction device. Such mobile phone can be configured to have one or more payment application installed thereon, such that the mobile phone can effectively act as a contactless card for transaction payment.

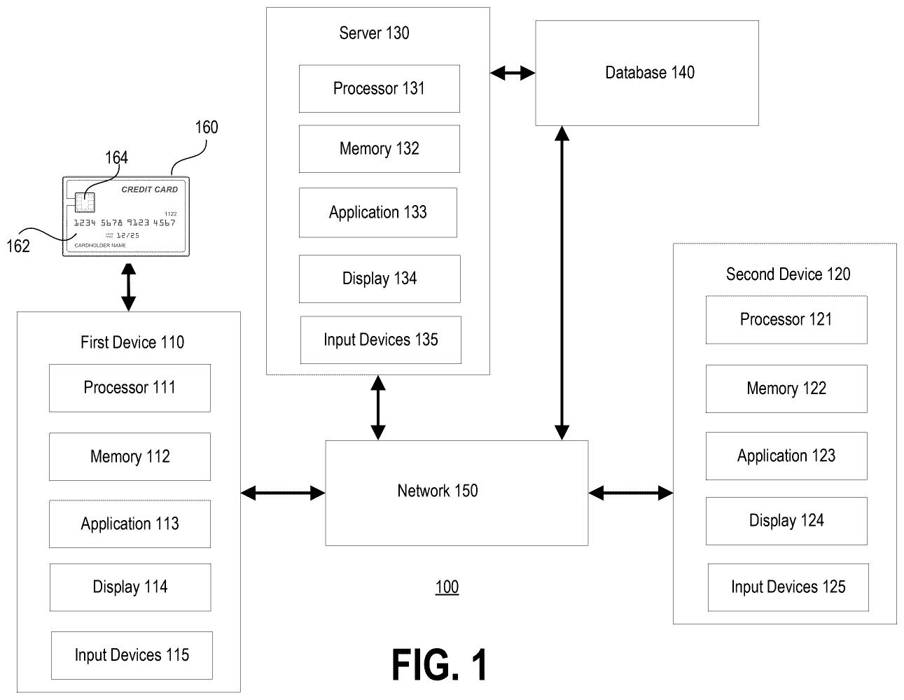

FIG. 1 illustrates a system 100 for disabling a contactless card for fraud prevention according to an example embodiment. As further discussed below, the system 100 may include a first device 110, a second device 120, a server 130, a database 140 in communication using a network 150, and a contactless card 160 in signal communication with the first device 110. Although FIG. 1 illustrates single instances of the components, the system 100 may include any number of components.

The first device 110 may be associated with a merchant with which transactions are conducted by a user, for example, the first device 110 may be a point of sale terminal device associated with the merchant. The first device 110 may be a user device (e.g., a mobile device) associated with the user for conducting online transactions, such as on line purchases. The first device 110 may also be configured to host an online shopping website of the merchant on which users may browse and/or purchase products and/or services provided by the merchant. The first device 110 can be configured to store online merchant accounts of users, and to present a shopping interface on which the users can conduct the transactions with the merchant.

The first device 110 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The first device 110 may include a processor 111, a memory 112, and an application 113. The processor 111 may be a processor, a microprocessor, or other processor, and the first device 110 may include one or more of these processors. The processor 111 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 111 may be coupled to the memory 112. The memory 112 may be a read-only memory, write-once read-multiple memory or read/write memory, e.g., RAM, ROM, and EEPROM, and the first device 110 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 112 may be configured to store one or more software applications, such as the application 113, and other data, such as user's shopping and financial account information.

The application 113 may comprise one or more software applications comprising instructions for execution on the first device 110. In some examples, the first device 110 may execute one or more applications, such as software applications, that, for example, enable network communications with one or more components of the system 100, transmit and/or receive data, and perform the functions described herein. Upon execution by the processor 111, the application 113 may provide the functions described in this specification, specifically to execute and perform the steps and functions in the process flows described herein. For example, the application 113 may be executed to perform authenticating a user or send an authentication request of authenticating the user to the server 130. The application 113 may also be executed to perform processing transactions of a user who may shop online from the merchant and/or collecting user risk data of the user. Such processes may be implemented in software, such as software modules, for execution by computers or other machines. The application 113 may provide graphical user interfaces (GUIs) through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The first device 110 may further include a display 114 and input devices 115. The display 114 may be any type of device for presenting visual information such as a computer monitor, a flat panel display, and a mobile device screen, including liquid crystal displays, light-emitting diode displays, plasma panels, and cathode ray tube displays. The input devices 115 may include any device for entering information into the first device 110 that is available and supported by the first device 110, such as a touch-screen, keyboard, mouse, cursor-control device, touch-screen, microphone, digital camera, video recorder or camcorder. These devices may be used to enter information and interact with the software and other devices described herein.

The second device 120 can be used by an entity such as a merchant for processing online transactions. The second device 120 can be a merchant server. The second device 120 may be configured to present to users a user interface from which the user may log into, for example, their online account. The second device 120 may also store transaction history of users, such as purchase history of the users including purchase place, purchase date, and purchase time.

The second device 120 may be a network-enabled computer device. Exemplary network-enabled computer devices include, without limitation, a contactless card, a server, a network appliance, a personal computer, a workstation, a phone, a handheld personal computer, a personal digital assistant, a thin client, a fat client, an Internet browser, a mobile device, a kiosk, a contactless card, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The second device 120 may include a processor 121, a memory 122, an application 123, a display 124, and input devices 125. The processor 121 may be a processor, a microprocessor, or other processor, and the second device 120 may include one or more of these processors. The processor 121 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 121 may be coupled to the memory 122. The memory 122 may be a read-only memory, write-once read-multiple memory or read/write memory, e.g., RAM, ROM, and EEPROM, and the second device 120 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 122 may be configured to store one or more software applications, such as the application 123, and other data, such as private and personal information.

The application 123 may comprise one or more software applications comprising instructions for execution on the second device 120. In some examples, the second device 120 may execute one or more applications, such as software applications, that, for example, enable network communications with one or more components of the system 100, transmit and/or receive data, and perform the functions described herein. Upon execution by the processor 121, the application 123 may provide the functions described in this specification, specifically to execute and perform the steps and functions in the process flows described herein. Such processes may be implemented in software, such as software modules, for execution by computers or other machines. The application 123 may provide graphic user interfaces (GUIs) through which users may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The second device 120 may further include a display 124 and input devices 125. The display 124 may be any type of device for presenting visual information such as a computer monitor, a flat panel display, and a mobile device screen, including liquid crystal displays, light-emitting diode displays, plasma panels, and cathode ray tube displays. The input devices 125 may include any device for entering information into the second device 120 that is available and supported by the second device 120, such as a touch-screen, keyboard, mouse, cursor-control device, touch-screen, microphone, digital camera, video recorder or camcorder. These devices may be used to enter information and interact with the software and other devices described herein such as selecting an option of creating an online account with the merchant.

The server 130 may be associated with an institution, such as a financial institution, and can be configured to communicate with the first device 110 and the second device 120. The institution associated with the server 130 may be a bank that issues a contactless card, such as the contactless card 160 for use by users to make purchases from the merchant, or a central bank authentication entity. The server may be configured to authenticate and/or verify a user based on the contactless card 160 associated with the user. The server 130 may also be configured to receive user risk data from the first device 110 and/or the second device 120.

The server 130 may be a network-enabled computer device. Exemplary network-enabled computer devices include, without limitation, a contactless card, a server, a network appliance, a personal computer, a workstation, a phone, a handheld personal computer, a personal digital assistant, a thin client, a fat client, an Internet browser, a mobile device, a kiosk, a contactless card, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 130 may include a processor 131, a memory 132, and an application 133. The processor 131 may be a processor, a microprocessor, or other processor, and the server 130 may include one or more of these processors. The processor 131 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 131 may be coupled to the memory 132. The memory 132 may be a read-only memory, write-once read-multiple memory or read/write memory, e.g., RAM, ROM, and EEPROM, and the server 130 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 132 may be configured to store one or more software applications, such as the application 133, and other data, such as user's financial account information and the contactless card information.

The application 133 may comprise one or more software applications, such as a card authentication module, comprising instructions for execution on the server 130. In some examples, the server 130 may execute one or more applications, such as software applications, that, for example, enable network communications with one or more components of the system 100, transmit and/or receive data, and perform the functions described herein. Upon execution by the processor 131, the application 133 may provide the functions described in this specification, specifically to execute and perform the steps and functions in the process flows described herein. For example, a card authentication module of the application 133 may be executed to perform authenticating and/or verifying a user based on the contactless card 160. Such processes may be implemented in software, such as software modules, for execution by computers or other machines. The application 133 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The server 130 may further include a display 134 and input devices 135. The display 134 may be any type of device for presenting visual information such as a computer monitor, a flat panel display, and a mobile device screen, including liquid crystal displays, light-emitting diode displays, plasma panels, and cathode ray tube displays. The input devices 135 may include any device for entering information into the server 130 that is available and supported by the server 130, such as a touch-screen, keyboard, mouse, cursor-control device, touch-screen, microphone, digital camera, video recorder or camcorder. These devices may be used to enter information and interact with the software and other devices described herein.

The database 140 may be one or more databases configured to store date, including without limitation, private information of users, financial accounts of users, contactless card information, online merchant account information, transactions of users, fraud risk data of users, and merchant records indicative of corresponding merchants. The database 140 may comprise a relational database, a non-relational database, or other database implementations, and any combination thereof, including a plurality of relational databases and non-relational databases. In some examples, the database 140 may comprise a desktop database, a mobile database, or an in-memory database. Further, the database 140 may be hosted internally by the server 130 or may be hosted externally of the server 130, such as by a server, by a cloud-based platform, or in any storage device that is in data communication with the server 130.

The system 100 may include one or more networks 150. In some examples, the network 150 may be one or more of a wireless network, a wired network or any combination of wireless network and wired network, and may be configured to connect the first device 110, the second device 120, the server 130, and the database 140. For example, the network 150 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 150 may include, without limitation, telephone lines, fiber optics, IEEE Ethernet 902.3, a wide area network, a wireless personal area network, a LAN, or a global network such as the Internet. In addition, the network 150 may support an Internet network, a wireless communication network, a cellular network, or the like, or any combination thereof. The network 150 may further include one network, or any number of the exemplary types of networks mentioned above, operating as a stand-alone network or in cooperation with each other. The network 150 may utilize one or more protocols of one or more network elements to which they are communicatively coupled. The network 150 may translate to or from other protocols to one or more protocols of network devices. Although the network 150 is depicted as a single network, it should be appreciated that according to one or more examples, the network 150 may comprise a plurality of interconnected networks, such as, for example, the Internet, a service provider's network, a cable television network, corporate networks, such as credit card association networks, and home networks. The network 150 may further comprise, or be configured to create, one or more front channels, which may be publicly accessible and through which communications may be observable, and one or more secured back channels, which may not be publicly accessible and through which communications may not be observable.

In some examples, communications between the first device 110, server 130, and second device 120 using the network 150 can occur using one or more front channels and one or more secure back channels. A front channel may be a communication protocol that employs a publicly accessible and/or unsecured communication channel such that a communication sent to the first device 110, server 130, and/or second device 120 may originate from any other device, whether known or unknown to the first device 110, server 130, and/or second device 120, if that device possesses the address (e.g., network address, Internet Protocol (IP) address) of the first device 110, server 130, and/or second device 120. Exemplary front channels include, without limitation, the Internet, an open network, and other publicly-accessible communication networks. In some examples, communications sent using a front channel may be subject to unauthorized observation by another device. In some examples, front channel communications may comprise Hypertext Transfer Protocol (HTTP) secure socket layer (SSL) communications, HTTP Secure (HTTPS) communications, and browser-based communications with a server or other device.

A secure back channel may be a communication protocol that employs a secured and/or publicly inaccessible communication channel. A secure back channel communication sent to the first device 110, server 130, and/or second device 120 may not originate from any device, and instead may only originate from a selective number of parties. In some examples, the selective number of devices may comprise known, trusted, or otherwise previously authorized devices. Exemplary secure back channels include, without limitation, a closed network, a private network, a virtual private network, an offline private network, and other private communication networks. In some examples, communications sent using a secure back channel may not be subject to unauthorized observation by another device. In some examples, secure back channel communications may comprise Hypertext Transfer Protocol (HTTP) secure socket layer (SSL) communications, HTTP Secure (HTTPS) communications, and browser-based communications with a server or other device.

The contactless card 160 may be any type of card, such as a security card, a payment card, an identification card, and the like. The contactless card 160 may be issued to a user by the bank for identity verification for the bank account of the user. The contactless card 160 can be used as an universal identifier (ID) of a user for identifying the user across multiple banks, so a social security card number is not needed for identifying the user across the multiple banks, which may enhance data security and user privacy.

The contactless card 160 can be configured to transmit a cryptogram to the first device 110 upon tapping to the first device 110. The first device 110 may be configured to read the cryptogram from the contactless card 160 after entry of the contactless card 160 into a communication field of the first device 110. The first device 110 may then transmit the cryptogram to the second device 120 or the server 130. The server 130 may be configured to verify the cryptogram by searching the database 140.

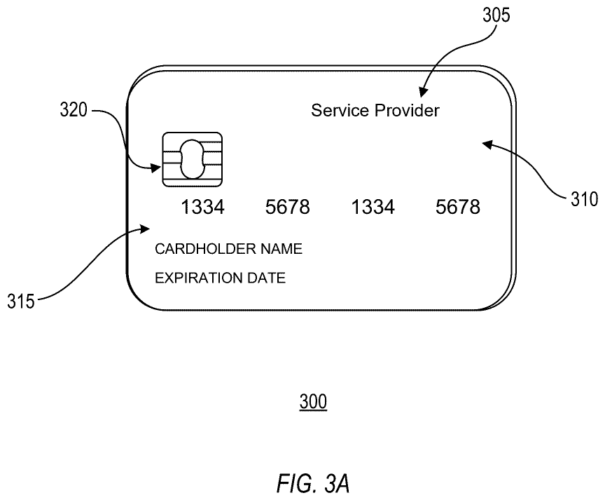

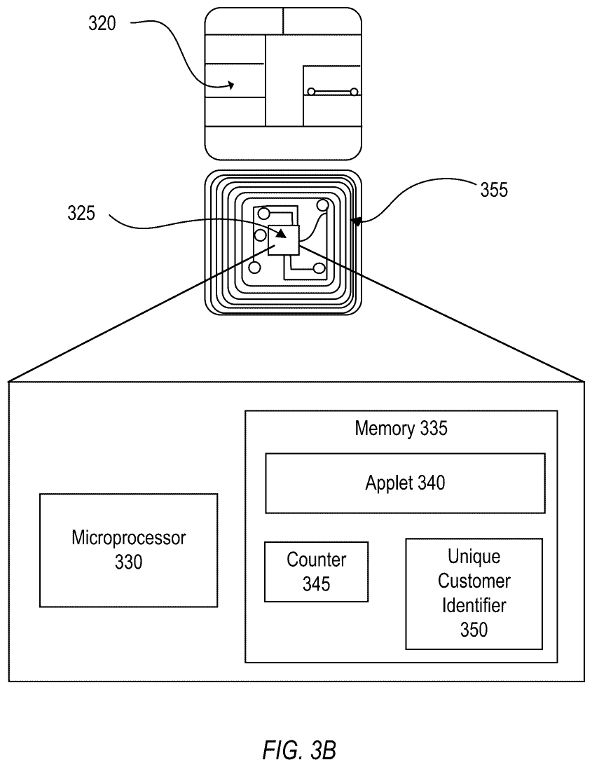

The contactless card 160 can perform authentication and numerous other functions that may otherwise require a user to carry a separate physical token in addition to the contactless card 160. By employing a contactless interface, the contactless card 160 may be provided with a method to interact and communicate between a user's device (such as a mobile phone) and the card itself. For example, the EMV protocol, which underlies many credit card transactions, includes an authentication process which suffices for operating systems for Android® but presents challenges for iOS®, which is more restrictive regarding near field communication (NFC) usage, as it can be used only in a read-only manner. Exemplary embodiments of the contactless card 160 described herein utilize NFC technology. The contactless card 160 may comprise a substrate 162 and a contact pad 164. Details of an example contactless card will be described in FIGS. 3A and 3B. The contactless card 160 can be disabled by the second device 120 or the server 130 when the contactless card 160 is determined to be fraudulent, stolen or lost.

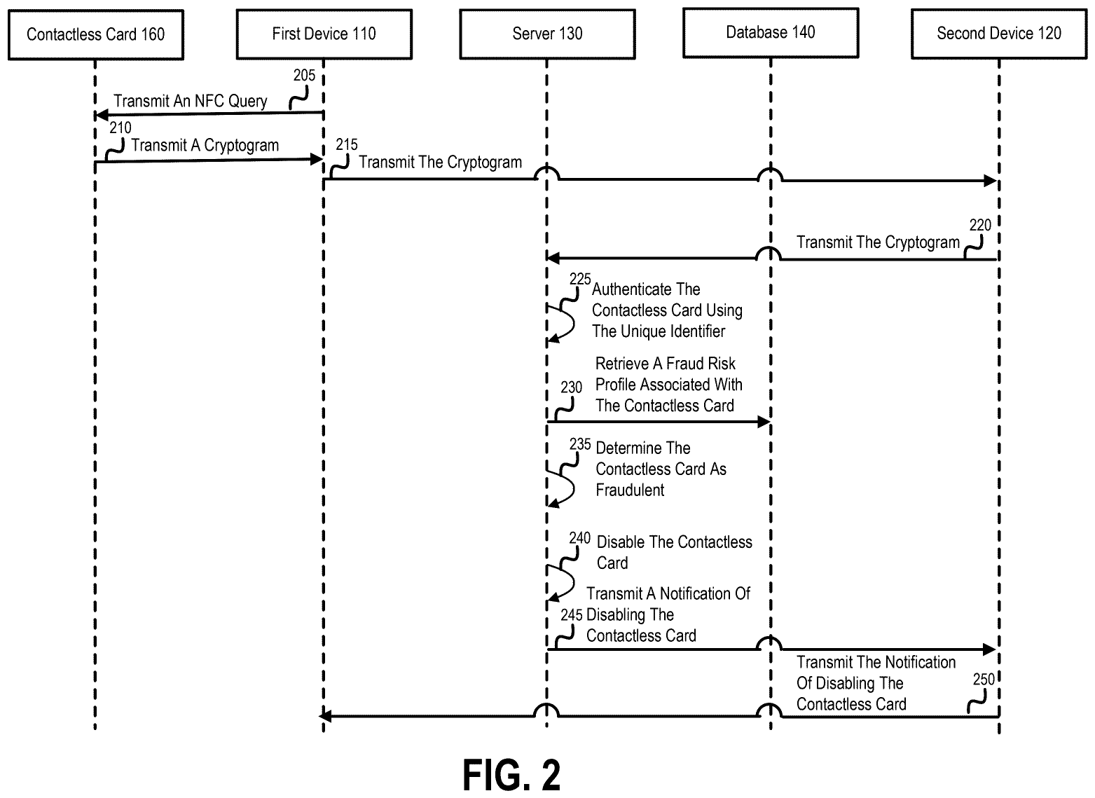

FIG. 2 illustrates an example diagram 200 of sequence interaction between the components of the system 100 according to an example embodiment. FIG. 2 may reference the same or similar components as those illustrated in FIG. 1, including a first device, a server, a database, a second device, and a contactless card.

When a user wants to make an online purchase or an offline purchase, in step 205, the first device 110 (e.g., a user mobile phone or a point of sale terminal device) may transmit an NFC query to the contactless card 160. The application 113 of the first device 110 may comprise an application from which the contactless card 160 can be read in that application. The first device 110 may be configured to be NFC-enabled and include an NFC interface configured for establishing an NFC communication with other NFC-equipped devices (the contactless card 160 in this embodiment). In some of these embodiments, the NFC interface of the first device 110 may be or include an NFC receiver configured for selectively activating a magnetic field for use in establishing near field communication with an NFC transmitter. The NFC interface of the first device 110 is configured for establishing NFC communication when a passive NFC tag or other NFC-enabled device is brought into the magnetic field and within the NFC communication range of the first device 110. The NFC interface of the first device 110 is configured, in particular, for communication with the NFC-enabled contactless card 160 when the contactless card 160 is brought within communication range of the first device 110 (such as, the contactless card 160 is tapped by the user to the first device 110). As used herein, a tap of the contactless card 160 to the first device 110 may indicate that the contactless card 160 is in a physical contact with the first device 110 and a tap of the contactless card 160 to the first device 110 may refer to entry of the contactless card 160 into the NFC communication field of the first device 110.

In response, after entry of the contactless card 160 into the NFC communication field of the first device 110, the contactless card 160 transmits, at step 210 to the first device 110 NFC response information (e.g., a cryptogram) usable by the server 130 to authenticate the user. The NFC response information may be or include, for example, security information encrypted by the contactless card 160 using a private key unique to the contactless card 160 that is known only to the server 130. The cryptogram may be stored in the memory of the contactless card 160. The cryptogram includes an unique identifier of the contactless card 160, which can be used as an universal identification of the user.

At step 215, the first device 110 transmits the NFC response information (the cryptogram) the second device 120. The second device 120 can be a device associated with the merchant such as a merchant server that communicates with the first device 110 (a mobile device of the user or a point of sale terminal of the merchant).

At step 220, the second device 120 transmits the cryptogram to the server 130. At step 225, the server 130 may authenticate the contactless card using the unique identifier. The server 130 may validate the cryptogram, decrypt the cryptogram and extract the unique identifier of the contactless card 160 through a card authentication module of the server 130. When the server 130 receives the cryptogram, the server 130 may decrypt the cryptogram after verifying the cryptogram. The server 130 may then extract the unique identifier of the contactless card 160 which is uniquely associated with the user. The server 130 may verify the unique identifier of the contactless card 160 by searching the database 140. The server 130 may authenticate the user based on the unique identifier of the contactless card 160.

After the contactless card 160 is authenticated, at step 230, the server 130 may retrieve from the database 140 a fraud risk profile associated with the contactless card 160. The fraud risk profile may include, without limitation: fraud risk data associated with the user when the user is browsing the website and/or purchasing products and/or services from the website; user behavioral data, for example, whether the user is browsing like a typical customer; network connection information, because the user's browser recognizes the user's connection to the website; geolocation of the user; browsing history of the user, for example, including time, location, website contents browsed; mouse movements while the user is browsing the website; the user device's orientation; fonts and language of the website; image data associated with the website; IP address of the user; hardware and software details, for example, user device details, operating system details, web browser details; first and/or third party cookies; autofill data; input logs; browser fingerprints, for example, what websites were visited by the browser; shared same network access information; and/or media access control address of the user device; previous transactions of the user at that merchant; recent changes to email or phone number of the user; signs of Account Take Over (ATO) attempts made by a third party on the user's account; and/or recent authentication in the bank application using a contactless card or other methods.

The fraud risk profile, which may be generated using a fraud risk machine learning model can indicate a trust level (which may also be referred to as a risk level) of the user of the contactless card of being a fraudulent actor. The trust level can be on a numerical scale, such as from 1 to 5 with 1 being a lowest trust level and 5 being a highest trust level. The trust level can also be categorized as a low trust level, a medium trust level, and a high trust level.

At step 235, the server 130 may determine the contactless card as fraudulent, based on the trust level determined from the fraud risk profile. The trust level may also be determined based on data during the transaction indicating a fraud is likely; the contactless card being reported as lost; the contactless card being reported as stolen; and/or a fraud reported on the contactless card to the bank.

At step 240, the server 130 may disable via the first device 110 the contactless card when determining the contactless card is fraudulent. The contactless card can be disabled in a number of ways when the contactless card is in data communication with the first device 110 such as a mobile device and/or a point of sale terminal, some of which can be reversible and others of which can be permanent (e.g., breaks the contactless card.) The disabling methods can include, but are not limited to: an overwrite the EMV applet of the contactless card, which can permanently disable the contactless card; a change the public keys of the contactless card so an initial authorization cannot occur, which can permanently disable the contactless card; a deletion of the public and private keys of the contactless card; a change the private key of the contactless card, which can be changed back to reactivate the contactless card; and a modification the EMV payment applet to accept a temporary disabling signal, which can be accomplished by sending a signed command to the contactless card and the contactless card can verify the signature of the signed command with an embedded public key.

At step 245, the server 130 may transmit a notification of disabling the contactless card to the second device 120. At step 250, the second device 120 may transmit the notification of disabling the contactless card to the first device 110, such that the user of the contactless card is notified that the contactless card is being disabled for being likely fraudulent.

This can enable to the contactless card to perform self-destruct or self-deactivating, which can offer some advantages. For example, a fraudulent actor could go into a store for an offline or online purchase. In that case, the contactless card would still validate because there has an authentication on the contactless card that actually indicates that it is a valid card. If the contactless card is determined to be fraudulent at that moment, the server can instruct the SDK to disable the contactless card through the NFC. That is, the disablement can be performed by the contactless card itself through the applet on the contactless card when instructed by the SDK. In some embodiments, the contactless card can be re-enabled, for example, by tapping the contactless card into the first device 110.

The applet on the contactless card can contain the keys (public and/or private keys) and secure elements such as APIs. The contactless card can be disabled by deleting the keys and secure element, which can cause the authentication would not work and effectively make the contactless card not function. In some embodiment, the applet on the contactless card can be changed to have a state where it always returns an error so it would never communicate again with the first device 110, whereby disabling the contactless card. In some embodiments, the SDK may transmit to the applet of the contactless card an update binary command that would disable the contactless card. In some embodiments, the contactless card can be reactivated by taping to the first device 110 to receive from the SDK a command with a message authentication code (MAC) created using a shared key between the contactless card and the SDK.

In some embodiments, a shared secret or secret key is needed for determining the validity of the disablement and reactivation message. A public key system can be used. For example, the MAC digital signature of the message can be signed by a private key and then the public key can be used to validate the signature on the contactless card. The public key can be stored on the contactless card. If the contactless card needs to be disabled or re-enabled, a signed message can be sent to the contactless card via application protocol data unit (APDU) command that would then either turn the contactless card on or off.

In some embodiments, disabling the contactless card can be performed during the same session of checkout. For example, when the contactless card is being tapped to the first device 110 to actually pay for a purchase, then in the process of validation of the contactless card, if the contactless card is determined as fraudulent, then in the same session a disable command can be sent by the SDK to the contactless card to disable the contactless card. In some other embodiments, the contactless card can be disabled in another session. For example, the user can be asked to tap the contactless card again for confirmation and when the contactless card is tapped for confirmation, the contactless card can be disabled.

The disabling command can be transmitted through a secure channel between the contactless card and the SDK. For example, certificates can be used to perform public key digital signatures. In some embodiments, the strength of the fraud profile signals can determine whether it is a reversible or permanent disablement to the contactless card.

In some embodiments, a trust level signal can be added to the cryptogram message of the contactless card that would be transmitted on each transaction. The applet of the contactless card can contain such protocol to include in the cryptogram message the trust level signal. For example, a trust level 4 can mean that everything with the contactless card goes through, and a trust level 0 can indicate the contactless card is likely fraudulent. The trust level 0 can trigger the SDK to transmit a disable command to the contactless card to disable the contactless card. A trust level 2 signal may cause to lower the limit on what a single transaction can be, for example, that might be down to $50 transactions, which cannot do anything over $50. If the fraud risk profile of the contactless card is improved, a command by the SDK can be written to the contactless card to enhance that trust level up to a more trustworthy level. The trust level can be adjusted by the SDK by writing to the contactless card each time. The rules on determining a trust level can be defined by the merchant or a bank that issues the contactless card. A third party involved in each transaction between the merchant and the bank can also intervene and set their own rules on that trust level.

The contactless card can contain public and private keys. The public key can be used for offline authentication and the private key can be used for online authentication. With the online authentication, the authentication of the contactless card can be performed by the server 130 (e.g., a bank server) using symmetric algorithm because there have a secret key on the contactless card and there have a secret key in the server 130. When the payment terminal is offline, the contactless card can be authenticated using the public key, for which there are RSA keys on the contactless card that are used. Disabling that public key is important for disabling the contactless card for these offline transactions.

FIG. 3A describes a contactless card 300 that can be used as the contactless card 160 in the system 100 of FIG. 1. The contactless card 300 is configured to communicate with the first device 110 and/or a user device of the user of system 100. The contactless card 300 may comprise a payment card, such as a credit card, debit card, or gift card, issued by a service provider 305 (such as a bank associated with the server 130) displayed on the front or back of the contactless card 300. In some examples, the contactless card 300 is not related to a payment card, and may comprise, without limitation, an identification card, a membership card, and a transportation card. In some examples, the contactless card 300 may comprise a dual interface contactless payment card.

The contactless card 300 may comprise a substrate 310, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 300 may have physical characteristics compliant with the ID-1 format of the ISO/IEC 7810 standard, and the contactless card 300 may otherwise be compliant with the ISO/IEC 14443 standard. However, it is understood that the contactless card 300 according to the present disclosure may have different characteristics, and the present disclosure does not require the contactless card 300 to be implemented in a payment card.

The contactless card 300 may also include identification information 315 displayed on the front and/or back of the contactless card 300, and a contact pad 320. The contact pad 320 may be configured to establish contact with another communication device, such as a user device, smart phone, laptop, desktop, or tablet computer. The contactless card 300 may also include processing circuitry, antenna and other components. These components may be located behind the contact pad 320 or elsewhere on the substrate. The contactless card 300 may also include a magnetic strip or tape, which may be located on the back of the contactless card 300.

FIG. 3B illustrates an example contact pad 320 of the contactless card 300. The contact pad 320 of the contactless card 300 may include processing circuitry 325 for storing and processing information, including a processor 330 and a memory 335. It is understood that the processing circuitry 325 may contain additional components, including processors, memories, error and parity/CRC checkers, data encoders, anticollision algorithms, controllers, command decoders, security primitives and tamperproofing hardware, as necessary to perform the functions described herein.

The memory 335 may be a read-only memory, write-once read-multiple memory or read/write memory, e.g., RAM, ROM, and EEPROM, and the contactless card 300 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. It may also be read many times.

In some embodiments, the memory 335 may also have stored public and private card encryption keys. In some embodiments, the private and public encryption keys may be permanently hard-wired into the memory 335. In various embodiments, the memory 335 may have stored therein instructions for generating encrypted information and transmitting it to a receiving device (e.g., the first device 110). Such encrypted information may be or include an encrypted verification block or signature that may be used to authenticate and verify the presence of the contactless card 300 during transaction processing. In some embodiments, encrypted information may be unique to a particular communication (e.g., a particular NFC transmission by the contactless card 300).

The memory 335 may be configured to store one or more applets 340, one or more counters 345, and a unique customer identifier 350. The one or more applets 340 may comprise one or more software applications configured to execute on one or more contactless cards, such as Java Card applet. The one or more applets 340 can be configured to disable the contactless card 300, as described above. However, it is understood that the one or more applets 340 are not limited to Java Card applets, and instead may be any software application operable on contactless cards or other devices having limited memory. The one or more counters 345 may comprise a numeric counter sufficient to store an integer. The unique customer identifier 350 may comprise a unique alphanumeric identifier assigned to a user of the contactless card 300, and the unique customer identifier 350 may distinguish the user of the contactless card 300 from other contactless card users and therefore can be an universal identifier for the user of that card. In some examples, the customer identifier 350 may identify both a customer and an account assigned to that customer and may further identify the contactless card 300 associated with the customer's account.

The processor 330 and memory 335 elements of the foregoing exemplary embodiments are described with reference to the contact pad 320, but the present disclosure is not limited thereto. It is understood that these elements may be implemented outside of the contact pad 320 or entirely separate from it, or as further elements in addition to the processor 330 and the memory 335 elements located within the contact pad 320.

In some examples, the contactless card 300 may comprise one or more antennas 355. The one or more antennas 355 may be placed within the contactless card 300 and around the processing circuitry 325 of the contact pad 320. For example, the one or more antennas 355 may be integral with the processing circuitry 325 and the one or more antennas 355 may be used with an external booster coil. As another example, the one or more antennas 355 may be external to the contact pad 320 and the processing circuitry 325.

In an embodiment, the coil of contactless card 300 may act as the secondary of an air core transformer. A terminal (such as the first device 110 or a user device of the user) may communicate with the contactless card 300 by cutting power or amplitude modulation. The contactless card 300 may infer the data transmitted from the terminal using the gaps in the contactless card's power connection, which may be functionally maintained through one or more capacitors. The contactless card 300 may communicate back by switching a load on the contactless card's coil or load modulation. Load modulation may be detected in the terminal's coil through interference.

As explained above, the contactless card 300 may be built on a software platform operable on smart cards or other devices having limited memory, such as JavaCard, and one or more applications or applets (e.g., applet 340) may be securely executed. Applets may be added to contactless cards to provide a one-time password (OTP) for multifactor authentication (MFA) in various mobile application-based use cases. Applets may be configured to respond to one or more requests, such as near field data exchange requests, from a reader, such as a mobile NFC reader, and produce an NDEF message that comprises a cryptographically secure OTP encoded as an NDEF text tag.

The contactless card 300 may be configured for communication with the first device 110 or a user device of the user via a communication interface configured for establishing communication with the first device 110 or the user device of the user. The communication interface may be configured for contact-based communication, in which case the interface may have electrical circuitry and contact pads on the surface of the contactless card 300 for establishing direct electrical communication between the contactless card 300 and the first device 110 or the user device of the user. Alternatively or in addition, the communication interface may be configured for contactless communication with the first device 110 or the user device of the user. In such embodiments, the communication interface may be or include an NFC communication interface configured for communication with other NFC communication devices when the contactless card 300 is within a predetermined NFC range. In some embodiments, the contactless card 300 may include a second communication interface configured for establishing short range communication with the first device 110 or the user device of the user via Bluetooth, or other short range communication methodology. In such embodiments, the contactless card 300 may have a short range communication antenna that is included in or connected to the short range communication interface. The contactless card 300 may also include a power management system for use in managing the distribution of power during an NFC transaction.

The contactless card 300 can be configured to transmit a cryptogram to the first device 110 or the user device of the user upon tapping to the first device 110 or the user device of the user, respectively. The first device 110 or the user device of the user may be configured to read the cryptogram from the contactless card 300 after entry of the contactless card 300 into a communication field of the first device 110 or the user device of the user. The first device 110 or the user device of the user may then transmit the cryptogram to the server 130. The server 130 may be configured to verify the cryptogram by searching the database 140.

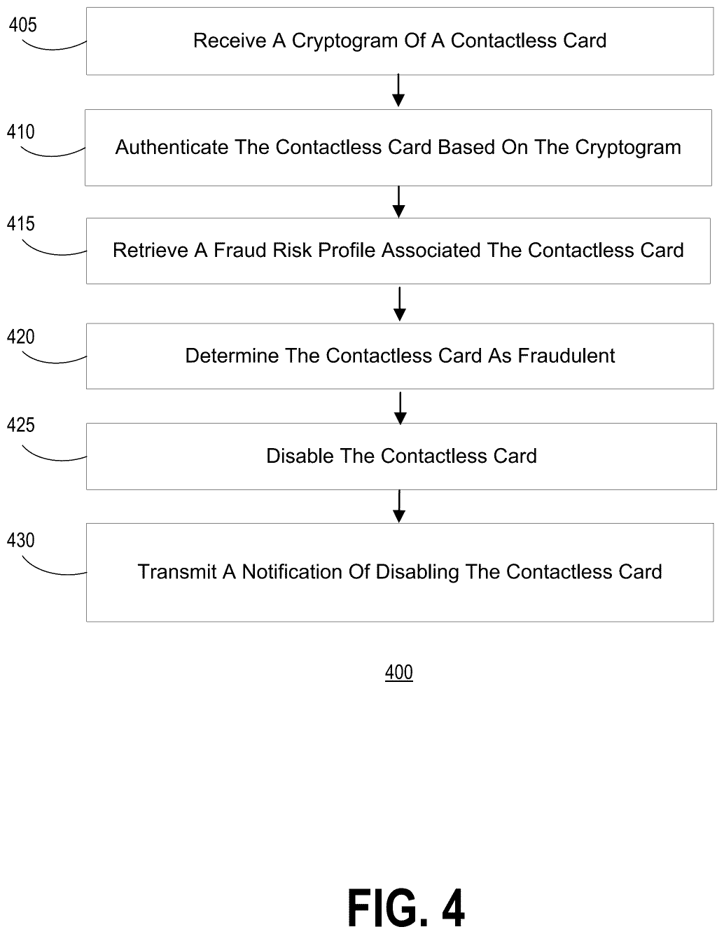

FIG. 4 illustrates a flow chart of an example method 400 for disabling a contactless card according to an example embodiment. FIG. 4 may reference the same or similar components as those illustrated in FIGS. 1, 2, 3A and 3B, including a first device and/or a user device, a server, a database, a second device, and a contactless card. The method 400 can be implemented in the system 100 and may include, but is not limited to the following steps.

As described above, when a user wants to make an online purchase or an offline purchase, the user may be asked to tap the contactless card 160 to the first device 110. In response, after entry of the contactless card 160 into the NFC communication field of the first device 110, the contactless card 160 transmits to the first device 110 NFC response information (e.g., a cryptogram) usable by the server 130 to authenticate the user/the contactless card 160. The cryptogram includes an unique identifier of the contactless card 160, which can be used as an universal identification of the user. The first device 110 can transmit the cryptogram to the second device 120. The second device 120 can be a device associated with the merchant such as a merchant server that communicates with the first device 110 (a mobile device of the user or a point of sale terminal of the merchant). The second device 120 transmits the cryptogram to the server 130. Accordingly at step 405, the server 130 receives the cryptogram of the contactless card 160.

At step 410, the server 130 may authenticate the contactless card based on the cryptogram. The server 130 may decrypt the cryptogram and extract the unique identifier of the contactless card 160 through a card authentication module of the server 130. The server 130 may verify the unique identifier of the contactless card 160 by searching the database 140. The server 130 may authenticate the user/the contactless card 160 based on the unique identifier of the contactless card 160.

After the contactless card 160 is authenticated, at step 415, the server 130 may retrieve from the database 140 a fraud risk profile associated with the contactless card 160. The fraud risk profile may include fraud risk data associated with the user. The fraud risk profile, which may be generated using a fraud risk machine learning model can indicate a trust level (which may also be referred to as a risk level) of the user of the contactless card of being a fraudulent actor. The trust level can be on a numerical scale, such as from 1 to 5 with 1 being a lowest trust level and 5 being a highest trust level. The trust level can also be categorized as a low trust level, a medium trust level, and a high trust level.

At step 420, the server 130 may determine the contactless card as fraudulent, based on the trust level determined from the fraud risk profile. The trust level may also be determined based on data during the transaction indicating a fraud is likely; the contactless card being reported as lost; the contactless card being reported as stolen; and/or a fraud reported on the contactless card to the bank.

At step 425, the server 130 may disable the contactless card when determining the contactless card is fraudulent. The contactless card can be disabled in a number of ways, some of which can be reversible and others of which can be permanent (e.g., breaks the contactless card.)

At step 430, the server 130 may transmit a notification of disabling the contactless card to the second device 120. The second device 120 may then transmit the notification of disabling the contactless card to the first device 110, such that the user of the contactless card 160 is notified that the contactless card 160 is being disabled for being likely fraudulent.

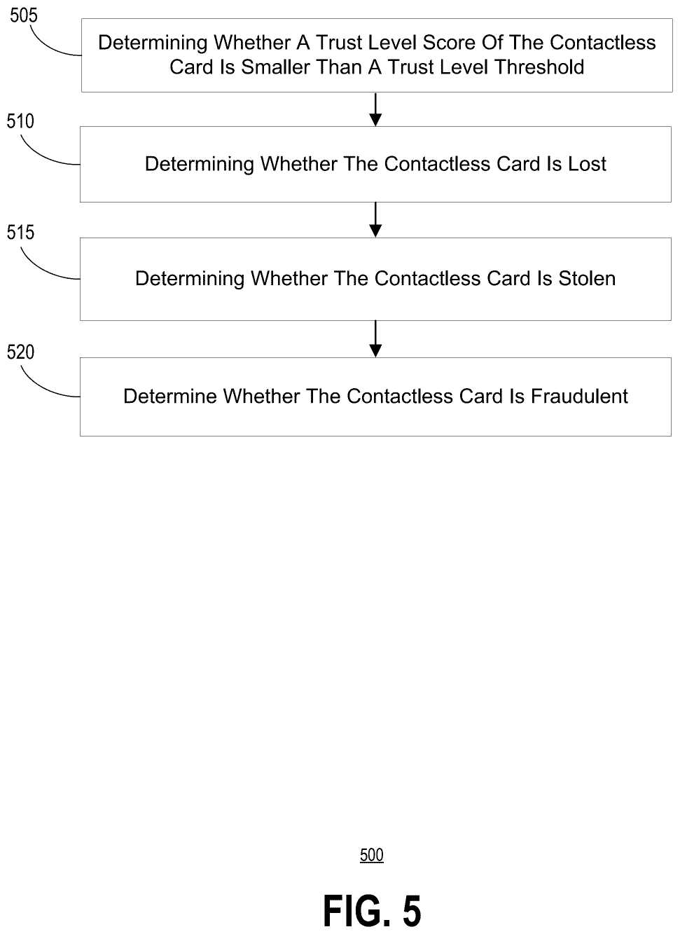

FIG. 5 illustrates a flow chart of an example method 500 of determining a contactless card as fraudulent according to an example embodiment. In block 505, the server 130 may retrieve the fraud risk profile associated with the contactless card 160. The fraud risk profile may include fraud risk data associated with the user. The fraud risk profile can indicate a trust level (which may also be referred to as a risk level) of the user of the contactless card 160 of being a fraudulent actor. The trust level can be on a numerical scale, such as from 1 to 5 with 1 being a lowest trust level and 5 being a highest trust level. The trust level can also be categorized as a low trust level, a medium trust level, and a high trust level. The server 130 may compare the trust level with a predetermined trust level threshold. The contactless card 160 may be determined fraudulent when determining that the trust level score of the contactless card 160 is less than the trust level threshold. In block 510, the server 130 may determine whether the contactless card 160 is lost. For example, the user of the contactless card 160 may report to the bank associated with the server 130 that the contactless card 160 has been lost. In block 515, the server 130 may determine that the contactless card is stolen. For example, the user of the contactless card 160 may report to the bank associated with the server 130 that the contactless card 160 has been stolen. In block 520, the server 130 can determine whether the contactless card 160 is fraudulent when one or more of the blocks 505, 510 and 515 is true.

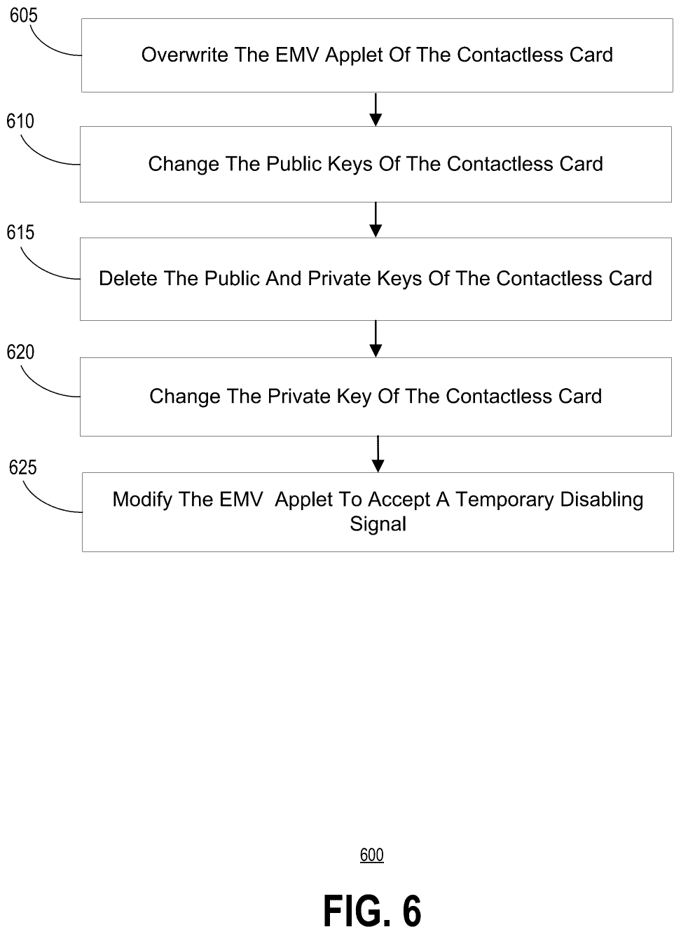

FIG. 6 illustrates a flow chart of an example method 600 of disabling a contactless card according to an example embodiment. The server 130 may disable the contactless card when determining the contactless card is fraudulent. The contactless card can be disabled in a number of ways, some of which can be reversible and others of which can be permanent (e.g., breaks the contactless card.) The disabling methods can include, but are not limited to: overwriting the EMV applet of the contactless card (shown in block 605), which can permanently disable the contactless card; changing the public keys of the contactless card so as to an initial authorization cannot occur (shown in block 610), which can permanently disable the contactless card; deleting the public and private keys of the contactless card (shown in block 615); changing the private key of the contactless card (shown in block 620), which can be changed back to reactivate the contactless card; and modifying the EMV payment applet to accept a temporary disabling signal (shown in block 625), which can be accomplished by sending a signed command to the contactless card and the contactless card can verify the signature of the signed command with an embedded public key. In some embodiments, the disabling methods can be performed in the sequence illustrated in FIG. 6, however, it is understood that in other embodiments the disabling methods can be performed in a different sequence. In addition, it is understood that only a subset of the disabling methods can be performed in other embodiments.

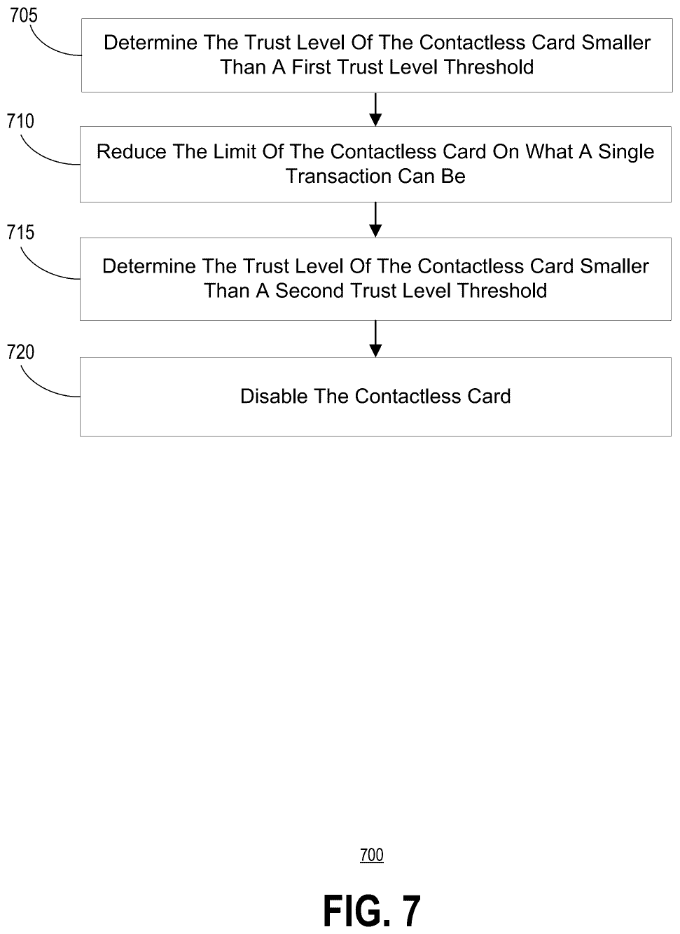

FIG. 7 illustrates a flow chart of an example method 700 for disabling a contactless card according to an example embodiment. FIG. 7 may reference the same or similar components as those illustrated in FIGS. 1-6, including a first device and/or a user device, a server, a database, a second device, and a contactless card. The method 700 can be implemented in the system 100 and may include, but is not limited to the following steps.

As described above, a trust level signal can be added to the cryptogram message of the contactless card that would be transmitted on each transaction. The applet of the contactless card can contain such protocol to include in the cryptogram message the trust level signal. For example, a trust level 4 can mean that everything with the contactless card goes through, and a trust level 0 can indicate the contactless card is likely fraudulent.

At step 705, the server 130 determines whether the trust level of the contactless card is less than a first trust level threshold. If the server 130 determines that the trust level of the contactless card is less than the first trust level threshold, then at step 710, the server 130 may reduce the limit on what a single transaction can be, for example, a reduction to $50/transaction from $200/transaction, and this means that the any transaction over $50 is not permitted. For example, at a first transaction, the trust level of the contactless card may be a level 2, which is less than a first trust level threshold (e.g., a trust level 4).

At step 715, the server 130 determines whether the trust level of the contactless card is less than a second trust level threshold. The second trust level threshold is less than the first trust level threshold. For example, the first trust level threshold can be a trust level 4 and the second trust level threshold can be a trust level 2. If the server 130 determines that the trust level of the contactless card is less than the second trust level threshold, then at step 715, the server 130 can disable the contactless card. For example, at a second transaction, the trust level of the contactless card may be a level 0, which is less than the second trust level threshold (a trust level 2). This can trigger the SDK to transmit a disable command to the contactless card to disable the contactless card.

In some embodiments, if the fraud risk profile of the contactless card is improved, a command by the SDK can be written to the contactless card to enhance that trust level up to a more trustworthy level, for example, the trust level of the contactless card can be enhanced from a level 0 to a level 2. If the trust level of the contactless card is enhanced, for example, above the second trust level threshold, the contactless card can be reactivated by the server 130 through the SDK.

In some aspects, the techniques described herein relate to a method of disabling a contactless card for fraud prevention, including: determining that the contactless card is fraudulent, including at least one selected from the group of determining that a trust level score of the contactless card is less than a trust level threshold, determining that the contactless card is lost, and determining that the contactless card is stolen; and disabling the contactless card, including at least one selected from the group of overwriting an applet on the contactless card, changing public keys on the contactless card, deleting public and private keys on the contactless card, changing a private key on the contactless card, and modifying a payment applet on the contactless card to accept a temporary disabling signal.

In some aspects, the techniques described herein relate to a method, wherein the applet on the contactless card is an EMV applet.

In some aspects, the techniques described herein relate to a method, wherein overwriting the applet on the contactless card permanently disables the contactless card.

In some aspects, the techniques described herein relate to a method, further including recovering the private key on the contactless card to reactivate the contactless card.

In some aspects, the techniques described herein relate to a method, further including: establishing a fraudulent profile for the contactless card; and generating the trust level score of the contactless card based on the fraudulent profile.

In some aspects, the techniques described herein relate to a method, wherein changing public keys on the contactless card causes an initial authentication not to take place on the contactless card.

In some aspects, the techniques described herein relate to a method, wherein disabling the contactless card is conducted over near field communication (NFC) from a phone.

In some aspects, the techniques described herein relate to a method, wherein changing public keys on the contactless card is to permanently disable the contactless card.

In some aspects, the techniques described herein relate to a system of disabling a contactless card for fraud prevention, including a server, wherein the server include a processor and a memory coupled to the processor, and the server is configured to: determine that the contactless card is fraudulent, including at least one selected from the group of determining that a trust level score of the contactless card is less than a trust level threshold, determining that the contactless card is lost, and determining that the contactless card is stolen; and disable the contactless card, including at least one selected from the group of at least one of overwriting an applet on the contactless card, changing public keys on the contactless card, deleting public and private keys on the contactless card, changing a private key on the contactless card, and modifying a payment applet on the contactless card to accept a temporary disabling signal.

In some aspects, the techniques described herein relate to a system, wherein the server is further configured to send a signed command to the contactless card to temporary disable the contactless card.

In some aspects, the techniques described herein relate to a system, wherein the server is further configured to cause the contactless card to verify a signature with an embedded public key in the signed command.

In some aspects, the techniques described herein relate to a system, wherein disable the contactless card is conducted through a software development kit (SDK) embedded in a merchant website.

In some aspects, the techniques described herein relate to a system, wherein the SDK communicates via one or more application programming interfaces (APIs) with the server.

In some aspects, the techniques described herein relate to a system, wherein challenges and public keys are held by the server and communicated over the one or more APIs to the SDK.

In some aspects, the techniques described herein relate to a system, wherein public key cryptography is used for mutual authentication of the contactless card and the SDK.

In some aspects, the techniques described herein relate to a non-transitory, computer-readable medium including instructions for disabling a contactless card for fraud prevention that, when executed on a computer arrangement, perform actions including: determining that the contactless card is fraudulent, including at least one selected from the group of at least one of determining that a trust level score of the contactless card is less than a trust level threshold, determining that the contactless card is lost, and determining that the contactless card is stolen; and disabling the contactless card, including at least one selected from the group of at least one of overwriting an applet on the contactless card, changing public keys on the contactless card, deleting public and private keys on the contactless card, changing a private key on the contactless card, and modifying a payment applet on the contactless card to accept a temporary disabling signal.

In some aspects, the techniques described herein relate to a non-transitory, computer-readable medium, wherein disabling the contactless card is conducted through a software development kit (SDK) embedded in a merchant website.

In some aspects, the techniques described herein relate to a non-transitory, computer-readable medium, wherein the contactless card and the SDK exchange digital certificates containing their public keys, which opens a secure communications channel between the contactless card and the SDK.

In some aspects, the techniques described herein relate to a non-transitory, computer-readable medium, wherein the SDK establishes a fraud profile of a user associated with the contactless card.

In some aspects, the techniques described herein relate to a non-transitory, computer-readable medium, wherein website cookies or IP addresses are used to evaluate the fraud profile of the user.

As used herein, the terms “bank” and “financial institution” are not limited to a particular bank or financial institution or type of bank or type of financial institution. Rather, it is understood that the present disclosure includes any type of bank, financial institution, or other business involved in activities where products or services are sold or otherwise provided.

As used herein, the term “merchant” is not limited to a particular merchant or type of merchant. Rather, it is understood that the present disclosure includes any type of merchant, vendor, or other entity involved in activities where products or services are sold or otherwise provided.

As used herein, the term “account” is not limited to a particular type of account. Rather, it is understood that the term “account” can refer to a variety of accounts, including without limitation, a financial account (e.g., a credit account, a debit account), a membership account, a loyalty account, a subscription account, a services account, a utilities account, a transportation account, and a physical access account. It is further understood that the present disclosure is not limited to accounts issued by a particular entity.

As used herein, the term “card” is not limited to a particular type of card. Rather, it is understood that the term “card” can refer to a contact-based card, a contactless card, or any other card, unless otherwise indicated. It is further understood that the present disclosure is not limited to cards having a certain purpose (e.g., payment cards, gift cards, identification cards, membership cards, transportation cards, access cards), to cards associated with a particular type of account (e.g., a credit account, a debit account, a membership account), or to cards issued by a particular entity (e.g., a commercial entity, a financial institution, a government entity, a social club). Instead, it is understood that the present disclosure includes cards having any purpose, account association, or issuing entity.

In some examples, exemplary procedures in accordance with the present disclosure described herein can be performed by a processing arrangement and/or a computing arrangement (e.g., a computer hardware arrangement). Such processing and/or computing arrangement can be, for example entirely or a part of, or include, but not limited to, a computer/processor that can include, for example one or more microprocessors, and use instructions stored on a computer-accessible medium (e.g., RAM, ROM, hard drive, or other storage device). For example, a computer-accessible medium can be part of the memory of a first device, a user device, a server, or other computer hardware arrangement.

In some examples, a computer-accessible medium (e.g., as described herein above, a storage device such as a hard disk, floppy disk, memory stick, CD-ROM, RAM, ROM, etc., or a collection thereof) can be provided (e.g., in communication with the processing arrangement and/or computing arrangement). The computer-accessible medium can contain executable instructions thereon. In addition or alternatively, a storage arrangement can be provided separately from the computer-accessible medium, which can provide the instructions to the processing arrangement so as to configure the processing arrangement to execute certain exemplary procedures, processes, and methods, as described herein above, for example.

It is further noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, and any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing and/or processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing and/or processing device receives computer readable program instructions from the network and forwards the computer readable program instructions for storage in a computer readable storage medium within the respective computing and/or processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application specific integrated circuit).

Throughout the disclosure, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “some examples,” “other examples,” “one example,” “an example,” “various examples,” “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrases “in one example,” “in one embodiment,” or “in one implementation” does not necessarily refer to the same example, embodiment, or implementation, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method of disabling a contactless card for fraud prevention, comprising:
determining that the contactless card is fraudulent, comprising at least one selected from the group of determining that a trust level score of the contactless card is less than a trust level threshold, determining that the contactless card is lost, and determining that the contactless card is stolen; and
disabling the contactless card, comprising at least one selected from the group of overwriting an applet on the contactless card, changing public keys on the contactless card, deleting public and private keys on the contactless card, changing a private key on the contactless card, and modifying a payment applet on the contactless card to accept a temporary disabling signal.

2. The method according to claim 1, wherein the applet on the contactless card is a Europay, Mastercard, and Visa (EMV) applet.

3. The method according to claim 1, wherein overwriting the applet on the contactless card permanently disables the contactless card.

4. The method according to claim 1, further comprising recovering the private key on the contactless card to reactivate the contactless card.

5. The method according to claim 1, further comprising:
establishing a fraudulent profile for the contactless card; and
generating the trust level score of the contactless card based on the fraudulent profile.

6. The method according to claim 1, wherein changing public keys on the contactless card causes an initial authentication not to take place on the contactless card.

7. The method according to claim 1, wherein disabling the contactless card is conducted over near field communication (NFC) from a phone.

8. The method according to claim 1, wherein changing public keys on the contactless card is to permanently disable the contactless card.

9. A system of disabling a contactless card for fraud prevention, comprising a server, wherein the server comprise a processor and a memory coupled to the processor, and the server is configured to:
determine that the contactless card is fraudulent, comprising at least one selected from the group of determining that a trust level score of the contactless card is less than a trust level threshold, determining that the contactless card is lost, and determining that the contactless card is stolen; and
disable the contactless card, comprising at least one selected from the group of at least one of overwriting an applet on the contactless card, changing public keys on the contactless card, deleting public and private keys on the contactless card, changing a private key on the contactless card, and modifying a payment applet on the contactless card to accept a temporary disabling signal.

10. The system according to claim 9, wherein the server is further configured to send a signed command to the contactless card to temporary disable the contactless card.

11. The system according to claim 10, wherein the server is further configured to cause the contactless card to verify a signature with an embedded public key in the signed command.

12. The system according to claim 9, wherein disable the contactless card is conducted through a software development kit (SDK) embedded in a merchant website.

13. The system according to claim 12, wherein the SDK communicates via one or more application programming interfaces (APIs) with the server.

14. The system according to claim 13, wherein challenges and public keys are held by the server and communicated over the one or more APIs to the SDK.

15. The system according to claim 12, wherein public key cryptography is used for mutual authentication of the contactless card and the SDK.

16. A non-transitory, computer-readable medium comprising instructions for disabling a contactless card for fraud prevention that, when executed on a computer arrangement, perform actions comprising:
determining that the contactless card is fraudulent, comprising at least one selected from the group of at least one of determining that a trust level score of the contactless card is less than a trust level threshold, determining that the contactless card is lost, and determining that the contactless card is stolen; and
disabling the contactless card, comprising at least one selected from the group of at least one of overwriting an applet on the contactless card, changing public keys on the contactless card, deleting public and private keys on the contactless card, changing a private key on the contactless card, and modifying a payment applet on the contactless card to accept a temporary disabling signal.

17. The non-transitory, computer-readable medium according to claim 16, wherein disabling the contactless card is conducted through a software development kit (SDK) embedded in a merchant website.

18. The non-transitory, computer-readable medium according to claim 17, wherein the contactless card and the SDK exchange digital certificates containing their public keys, which opens a secure communications channel between the contactless card and the SDK.

19. The non-transitory, computer-readable medium according to claim 17, wherein the SDK establishes a fraud profile of a user associated with the contactless card.

20. The non-transitory, computer-readable medium according to claim 19, wherein website cookies or internet protocol (IP) addresses are used to evaluate the fraud profile of the user.
